(19) United States
(12) Patent Application Publication
(10) Pub. No.: US 2023/0402872 A1
(43) Pub. Date: Dec. 14, 2023

(54) A COIL STRUCTURE FOR IMPEDANCE MATCHING IN A WIRELESS POWER TRANSFER SYSTEM

(71) Applicant: UNIVERSITY OF SOUTH-EASTERN NORWAY, Kongsberg (NO)

(72) Inventors: Mehdi AZADMEHR, Horten (NO); Yelzhas ZHAKSYLYK, Ixelles (BE)

(21) Appl. No.: 18/035,041

(22) PCT Filed: Nov. 1, 2021
(86) PCT No.: PCT/EP2021/080237

§ 371 Date: May 2, 2023

(30) Foreign Application Priority Data
Nov. 3, 2020 (NO) 20201197

(51) Int. Cl. H02J 50/00; H02J 50/40; H02J 50/10

(52) U.S. Cl. CPC H02J 50/005; H02J 50/402; H02J 50/10

(57) ABSTRACT

The invention relates to a switchable multiturn coil antenna for transmitting or receiving wireless power in a wireless power transfer system and a corresponding wireless power transfer system. The coil structure includes a planar multiturn primary conductor coil (5) and at least two secondary conductor coils (1, 2, 3, 4) positioned in the plane defined by the primary coil between the turns of the multiturn primary coil, each of the secondary coils having different sizes and lengths providing different inductance and are shorter than the primary coil, wherein each secondary coils is connected to a respective switch (9,10,11, 12) controlled by a tuning controller (23) for individually connecting and disconnecting the coil to a load or to a power supply. An impedance (8) is be connected between the ends of the primary coil and each of the secondary coils extends one turn around a common coil center.

Wireless charging has become increasingly popular the recent years, most know for charging mobile phones and smaller home appliance, but also for other uses. A common solution in the known arts uses magnetic resonant wireless power transfer (MRWPT) system. However, MRWPT systems are highly sensitive to distance changes and misalignments between transmitter and receiver coils which causes an impedance mismatch between the coupled coils. An effective impedance matching network (IMN) can solve the mismatch problem.

A large number of different IMN circuits are known for WPT systems, as shown in references [1]-[16]. Most of them use a capacitive matching technique, which includes capacitor matrices, variable capacitors, or a sequence of predefined capacitors in L-, T-, or Pi-matching circuitry [1]-[5]. Another method is the inductive IMN, where several coils are placed in proximity of the transmitter or receiver coils for the impedance matching purpose. These coils can be regarded as a multi-loop transformer with several inputs and a single output [6]-[8]. The working principle resembles the four-coil magnetic resonance WPT system presented by the MIT group in 2007 [9]. This system consists of two or more high-Q resonator coil, which are driven by a low-Q coil connected to the power source. The load is also connected to a low-Q coil. The coupling between the resonator and the driving coil (or the load coil) can be considered as part of a matching network, where the tuning of the impedance can be achieved by changing the coupling between them. This method was referred to as inductive IMN in reference [10], where switchable driving coils are placed on the backside and a high-Q transmitter coil is placed on front-side of the same PCB. In that work, it is demonstrated that coupling between high-Q and low-Q coils varies linearly and therefore, it can be used as inductive IMN.

The object of the present invention is to improve the impedance matching of WPT systems. This is obtained as specified in the accompanying claims.

More specifically the object is obtained using interspiraled switchable coils for inductive impedance matching network (IMN) of magnetic resonance wireless power transfer (WPT). Switching between different values of inductance can be used for compensation of distance changes and misalignment between transmitter and receiver coils in Wireless Power Transfer (WPT) systems.

The preferred embodiment of invention thus relates to an interspiraled switchable inductor system, which can be modelled as a multi-coil magnetic resonance WPT system with multiple driving coils and load coil. The selection of different driving and load coils can be used to compensate distance changes and misalignments between resonator coils. Each interspiraled coils can be selected using switches controlled by a control system. Both the interspiraled coils and the resonator coil can be placed one side of PCB, therefore, it is more compact.

The present invention will be described below referring to the accompanying drawings, illustrating the invention by way of examples.

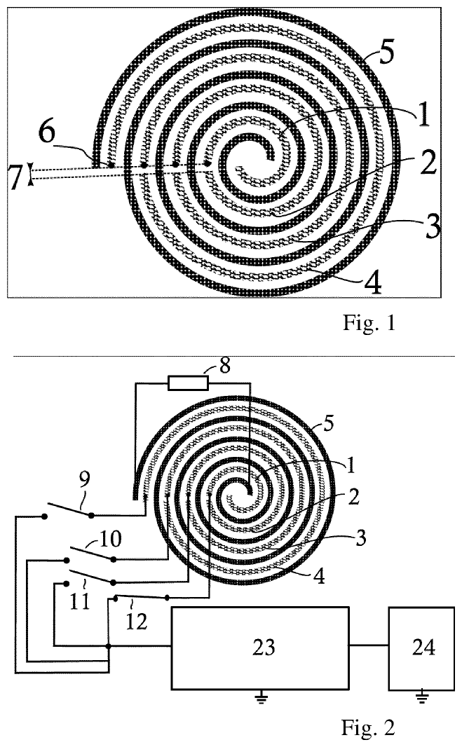

FIG. 1 illustrates the coil structure of the preferred embodiment of the invention with interspiraled coils and spiral shaped resonator coil.

FIG. 2 illustrates the circuitry related to the interspiraled coils and spiral shaped resonator coil connected to the power supply or load with selectable switches.

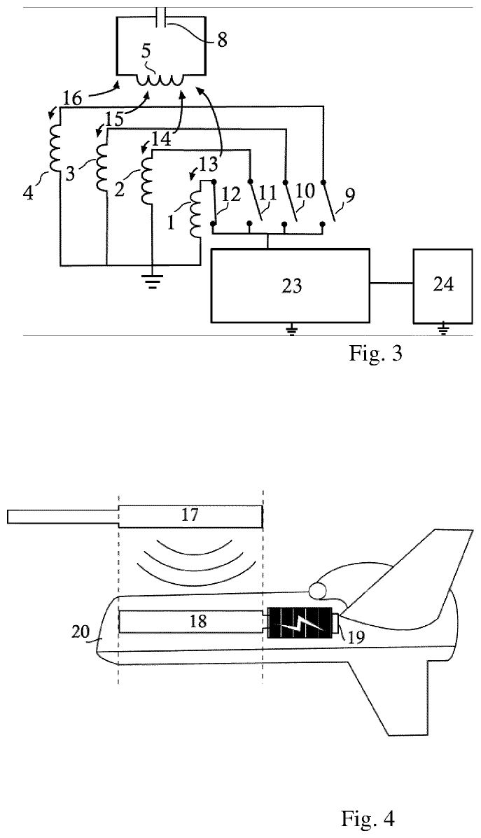

FIG. 3 illustrates a circuit representation of the interspiraled coils and spiral shaped resonator coil.

FIG. 4 illustrates an example of use related to an electric autonomous submarine wireless charging station.

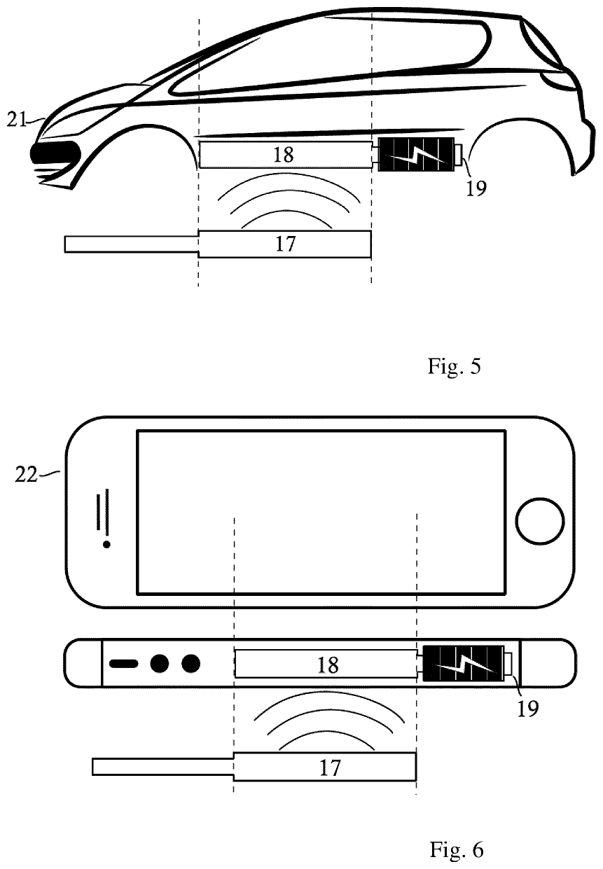

FIG. 5 illustrates an example of use related to an electric car wireless charging station.

FIG. 6 illustrates an example of use related to an electric device wireless charging station.

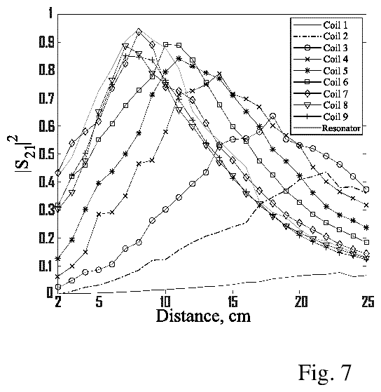

FIG. 7 illustrates the dependency of power transfer to distance using different coils.

The PCB view of the coil structure is shown in FIG. 1. The different single loop driving coils 1,2,3,4 are placed between the turns of the spiral-shaped multi-turn resonator (transmitter/receiver) coil 5. 6 are via connections to the backside of PCB, 7 is a gap between the interspiraled coils 1,2,3,4. The interspiraled coils thus represent different inductances and will provide resonance under different conditions, such as changing distance from the device to be charged.

As all the coils are placed on one side of a PCB, backside of PCB can be used for other necessary electronic circuitry such as the control system, amplifier and their connections. Therefore, the system becomes more compact.

The interspiraled switchable coils can be modelled in the same way as a four-coil magnetic resonance WPT system, but with multiple driving coils. Selecting the different single loop coils results in different mutual inductances which can again be used for compensation of distance changes and misalignment between resonators. Each driving loop can be selected using switches controlled by a control system

FIG. 2 illustrates connections of interspiraled coils 1,2,3,4 to the tuning control system 23 and power supply or battery 23. The interspiraled coils 1,2,3,4 will be activated and disabled through switches 9,10,11,12. Switches can be MOSFET transistors or relays.

The interspiraled switchable coils illustrated in FIG. 2 consists of four single turn coils with increasing radius, each numbered from 1 to 4 as shown in the figure. Mosfet transistors or relays can be used to connect the power source to the different driving coils. Basic working principle of such a system is well explained in reference [8].

FIG. 3 illustrates a schematic view of that connections and mutual inductances 13,14,15,16 representation. As it can be seen from FIG. 3 the spiral-shaped resonator coil 5 and each driving coil 1,2,3,4 are mutually coupled, the mutual inductances are labelled from 13 to 16 in the figure relative to the resonator coil 5. The resonator coil 5 is connected to a chosen capacitor 8 so a predetermined resonance frequency at an ISM band can be achieved.

FIG. 4 shows an application for use of a system according to the invention including drone, e.g. an electric-autonomous submarine, 20 charging station, which consists of Transmitter 17 and built-in receiver 18 on the boat. Both transmitter 17 and receiver 18 includes identical coil structures as illustrated above with only difference that transmitter 17 is connected to the power supply and receiver 18 has connection to the load. Receiver is connected to the load, i.e. battery 19. Each of the transmitter 17 and receiver 18 contains a coil system as illustrated in FIG. 2. The charging unit 17 containing a transmitter coil, as shown in FIG. 2 is placed in a distance of 10 cm from the drone. A power receiver unit 18 containing the proposed coil as shown in FIG. 2, is placed inside the drone directed toward the transmitter unit. The transmitted power is being used to charge the battery 19 inside the drone. If the distance changes, the system automatically optimizes the power transferred by changing the driving coils in the proposed system. If the distance is decreased, a smaller coil is selected and if the distance decreases, a larger coil is selected.

Other uses may also be contemplated such as charging electrical cars or electronic devices, wherein the dimensions and distances will depend on the use. For example FIG. 5 shows a vehicle 21 which is charged by the proposed system. The charging unit 17 containing a transmitter coil, as shown in FIG. 2, is placed in a distance of 20-40 cm from the vehicle. A power receiver unit 18 containing the proposed coil as shown in FIG. 2, is placed inside the vehicle directed toward the transmitter unit. FIG. 6 shows a mobile phone 22 which is charged by the proposed system. The charging unit 17 containing a transmitter coil as shown in FIG. 2 may be placed under a table, and mobile phone is placed in a distance of 4 cm from the power transmitter. The sizes and other characteristics will be adjusted according to these uses.

FIG. 7 exemplifies a measure of the square magnitudes of the measured transmission coefficient parameters as function of the distance between transmission and receiver resonator at 5.3 MHz using a resonator coil 5 at approximately 10 cm and nine interspiraled coils. The measurement shows that we can achieve an active matching for distance changes from 7 cm to 25 cm with 1 cm steps from 2 to 25 cm.

The tuning controller 23 in the receiver 17 or transmitter 18 will preferably switch both coil structures to match the signal of each other but under certain conditions it may be contemplated that only switch one, thus providing two non-identical characteristics for the two coils.

To summarize the present invention thus relates to a multiturn coil antenna for transmitting or receiving wireless power in a wireless power transfer system.

The coil structure includes a plane multiturn primary conductor coil and at least two secondary conductor coils positioned in the plane defined by the primary coil and being placed between the turns of the multiturn primary coil, thus having a spiral shape relative to the same center. The secondary coils have different diameters and lengths therefore provide different inductance and are also shorter than the primary coil. Each secondary coil is connected to a switch configured to be controlled by a tuning controller for individually connecting and disconnecting the coil to a battery for receiving said power, e.g. for charging, or to a power supply, thus either transmitting or receiving radiation within a predetermined frequency range.

According to an embodiment of the invention the two or more secondary coils can be connected in series or parallel may also be configured to be connected in series or in parallel to increase the number of possibilities and different resonance properties.

Preferably each of the secondary coils extend one turn around the common coil centers, and the primary coil is at each end connected to an impedance, thus providing a resonator.

The coils may be positioned on a surface of insulating material, possibly covered by another insulating layer, or may be implemented inside a suitable material.

The present invention also relates to a wireless power transfer system including two coil preferably identical antennas as discussed above, one in the transmitter and one in the receiver. The first being connected to a power supply and the second being connected to drive a load or a battery to be charged with said power. Thus, when positioned in a position relative to each other the transmitted power from one antenna may be received by the other, and by selecting the secondary coils an optimized coupling between the two may be achieved.

Preferably, to achieve this at least one tuning controller includes a sensing circuit for sensing resonance quality at each of said coil antennas and switching between the secondary antennas until the best matched impedance is achieved.

The tuning control of the receiver and transmitter antenna may be configured to choose the secondary coil providing the highest power reception and/or the transmitter and receiver is provided with a wireless communication means so as to choose the antenna configuration at both the transmitter and receiver providing the highest transfer efficiency.

Several uses of the deice according to the invention may be contemplates, such as where a first of said antennas are connected to a power supply located in a stationary installation at a ground level and the second of said antennas is located in a moving vehicle, such as a car, and connected to a chargeable battery, the second antenna being positioned in the vehicle at a predetermined height above the ground level.

Another embodiment is related to submarine vessels where a first of said antennas are connected to a power supply located in a stationary submarine installation and the second of said antennas is located in an electrically operated submarine vessel and connected to a chargeable battery in the vessel, the vessel being configured to move into a position at a predetermined position relative to the first antenna.

A third embodiment is related to charging mobile devices where a first of said antennas are connected to a power supply located in a stationary installation and the second of said antennas is located in a mobile electronic device and being connected to a chargeable battery in the device, the installation including a surface for placing the device in a predetermined position relative to the first antenna.

### REFERENCES

[1] O. Abdelatty, X. Wang and A. Mortazawi, “Position-Insensitive Wireless Power Transfer Based on Nonlinear Resonant Circuits,” in IEEE Transactions on Microwave Theory and Techniques, vol. 67, no. 9, pp. 3844-3855, September 2019. doi: 10.1109/TMTT.2019.2904233
[2] B. K. Eplett, “On-chip impedance matching using a variable capacitor”, U.S. Patent 2008/0211598 A1, Sep. 4, 2008.
[3] W. Lee, H. Lee, K. Oh, and J. Yu, “Switchable distance-based impedance matching networks for a tunable HF system”, Progr. Electromagn. Res., vol. 128, pp. 19-34, 2012.
[4] Y. Lim, H. Tang, S. Lim and J. Park, “An Adaptive Impedance-Matching Network Based on a Novel Capacitor Matrix for Wireless Power Transfer”, in IEEE Transactions on Power Electronics, vol. 29, no. 8, pp. 4403-4413, August 2014.
[5] J. Kim, D. H. Kim and Y. J. Park, “Analysis of Capacitive Impedance Matching Networks for Simultaneous Wireless Power Transfer to Multiple Devices”, in IEEE Transactions on Industrial Electronics, vol. 62, no. 5, pp. 2807-2813, May 2015.
[6] P. Park, C. S. Kim, M. Y. Park, S. D. Kim and H. K. Yu, “Variable inductance multilayer inductor with MOSFET switch control,” in IEEE Electron Device Letters, vol. 25, no. 3, pp. 144-146, March 2004.
[7] B. Park and J. Lee, “Adaptive Impedance Matching of Wireless Power Transmission Using Multi-Loop Feed With Single Operating Frequency,” in IEEE Transactions on Antennas and Propagation, vol. 62, no. 5, pp. 2851-2856, May 2014. doi: 10.1109/TAP.2014.2307340
[8] Y. T. Song, J. J. Wang and X. M. Li, “Printed spiral coils with multiloop technique for planar magnetically coupled resonant wireless power transfer system,” 2018 IEEE MTT-S International Wireless Symposium (IWS), Chengdu, 2018, pp. 1-3. doi: 10.1109/IEEE-IWS.2018.8400960
[9] A. Kurs, “Power transfer through strongly coupled resonances, Massachusetts Institute of Technology”, Master Thesis, 2007.
[10] Y. Zhaksylyk, U. Hanke, M. Azadmehr, “Design of a switchable driving coil for Magnetic Resonance Wireless Power Transfer”, IEEE PELS Workshop on Emerging Technologies: Wireless Power, 2019.
[11] US2016/0380469
[12] US2015/0255987
[13] WO2019/148070
[14] WO2020/167245
[15] U.S. Pat. No. 4,087,821
[16] U.S. Pat. No. 5,619,218

1-12. (canceled)

13. A multiturn coil antenna for transmitting or receiving wireless power in a wireless power transfer system, the coil structure comprising a plane multiturn spiral shaped primary conductor coil and at least two secondary conductor coils positioned in the plane defined by the primary coil and interspiraled between the turns of the multiturn primary coil on an insulating material, each of the secondary coils having different diameters and lengths providing different inductance and are shorter than the primary coil, wherein each secondary coils is connected to a switch configured to be controlled by a tuning controller for individually connecting and disconnecting the coil to a battery for receiving said power or to a power supply.

14. A multiturn coil antenna according to claim 13, wherein each of the secondary coils extend one turn around the common coil center.

15. A multiturn coil antenna according to claim 13, wherein the primary coil is at each end connected to an impedance, thus providing a resonator.

16. A multiturn coil antenna according to claim 13, wherein two or more of the secondary coils can be connected in series or parallel.

17. Wireless power transfer system comprising two coil antennas according to claim 13, the first being connected to a power supply and the second being connected to drive a load or a battery to be charged with said power.

18. Wireless power transfer system according to claim 17, wherein said at least one tuning controller includes a sensing circuit for sensing resonance quality at each of said coil antennas and switching between the secondary antennas until the best matched impedance is achieved.

19. Wireless power transfer system according to claim 18, wherein the tuning controller of the receiver and transmitter antenna is configured to choose the secondary coil providing the highest power reception.

20. Wireless power transfer system according to claim 18, wherein the transmitter and receiver is provided with a wireless communication means so as to choose the antenna configuration at both the transmitter and receiver providing the highest transfer efficiency.

21. Wireless power transfer system according to claim 17, wherein a first of said antennas are connected to a power supply located in a stationary installation at a ground level and the second of said antennas is located in a moving vehicle, such as a car, and connected to a chargeable battery, the second antenna being positioned in the vehicle at a predetermined height above the ground level.

22. Wireless power transfer system according to claim 17, wherein a first of said antennas are connected to a power supply located in a stationary submarine installation and the second of said antennas is located in a electrically operated submarine vessel and connected to a chargeable battery in the vessel, the vessel being configured to move into a position at a predetermined position relative to the first antenna.

23. Wireless power transfer system according to claim 17, wherein a first of said antennas are connected to a power supply located in a stationary installation and the second of said antennas is located in a mobile electronic device and being connected to a chargeable battery in the device, the installation including a surface for placing the device in a predetermined position relative to the first antenna.
